(19) United States
(12) Patent Application Publication
(10) Pub. No.: US 2025/0386848 A1
(43) Pub. Date: Dec. 25, 2025

(54) POWDER ATTACHMENT DEVICE AND METHOD FOR FOOD

(71) Applicant: RHEON AUTOMATIC MACHINERY CO., LTD., Tochigi (JP)

(72) Inventors: Yuzo TOKUHARA, Tochigi (JP); Atsushi SASAKAWA, Tochigi (JP); Kenichi KATO, Tochigi (JP)

(21) Appl. No.: 18/842,958

(22) PCT Filed: Mar. 6, 2023
(86) PCT No.: PCT/JP2023/008287

§ 371 Date: Apr. 4, 2025

(30) Foreign Application Priority Data
Mar. 4, 2022 (JP) 2022-033070

(51) Int. Cl. A23P 20/12

(52) U.S. Cl. CPC A23P 20/12

(57) ABSTRACT

A powder attachment device and method for attaching powder to a desired range of a food product are provided. The powder attachment device (1) for attaching powder (11) to a surface of a food product (10) according to the present invention includes a conveyor (5) with a conveying surface (5B) for conveying the food product; and at least one rotating body (3A, 3B) disposed on both sides of the conveying surface. The rotating body is configured to throw powder (11) toward the food product, which is conveyed by the conveying surface, by rotations of the rotating body. The rotating body is configured to allow its rotational speed to be repeatedly changed while the powder is thrown.

### TECHNICAL FIELD

The present invention relates to a device and method for attaching powder to surfaces of a food product. Specifically, the present invention relates to a device and method for attaching powder to surfaces of a food product by supplying the powder to a rotating body (a surface of a flat rotating plate or a rotating brush), and throwing the powder toward the food product due to rotations of the rotating body.

### BACKGROUND ART

A powder attachment device disclosed in the Patent Document 1 includes a conveyor for conveying a food product, a rotating body disposed on a side of the conveyor, and a powder supplying mechanism for supplying the powder to the rotating body, wherein the rotating body has a rotatable rotating shaft and at least one planar rotating plate provided on the rotating shaft. In this powder attachment device, a height level from which the powder is thrown can be adjusted by changing a height level of the rotating plate. Further, in this powder attachment device, an amount of powder thrown per rotation of the rotating plate can be adjusted by adjusting a rotational speed of the rotating plate.

Further, the powder attachment device disclosed in the Patent Document 1 includes, for example, two pairs of rotating bodies disposed to sandwich the conveyor. Each rotating body includes a rotating shaft disposed perpendicular to a conveying surface of the conveyor, and upper and lower rotating plates which are attached to the rotating shaft and spaced from each other by a vertical distance. Namely, the upper rotating plate and the lower rotating plate are disposed parallel to the conveying surface of the conveyor.

A powder attachment device disclosed in the Patent Document 2 includes a conveyor defining a passage for a food product, a pair of rotating brushes disposed to sandwich the conveyor and opposing to each other, and a powder supplying mechanism for supplying powder to the rotating brushes from a location above them. The powder attachment device further includes a force adjusting means for adjusting a force for throwing the powder from the rotating brush toward the food product, and a direction adjusting means for adjusting a height direction (angle) of the powder thrown from the rotating brush to the food product. The direction adjusting means is configured by a movable inclined plate and a moving device for moving the inclined plate.

A powder attachment device described in the Patent Document 3 has two pairs of rotating bodies disposed on a side of a conveyor. Each rotating body includes a rotating shaft and a brush attached to the rotating shaft. Further, the powder attachment device has a pin so that the rotating brush contacts the pin when the powder is thrown from the rotating brush.

### PRIOR ART

### Patent Document

Patent Document 1: Japanese Patent Laid-open Publication No. 2014-236706

Patent Document 2: Japanese Patent Laid-open Publication No. H 09-000234

Patent Document 3: Japanese Patent Laid-open Publication No. H 09-023862

### SUMMARY OF THE INVENTION

### Problem to be Solved by the Invention

In the powder attachment device described in the Patent Document 1, the powder is horizontally thrown from the upper rotating plate and falls along a parabolic trajectory, so that the powder is mainly attached to a top surface and a side surface of a food product. Further, the lower rotating plate is disposed close to the conveying surface, and the powder is thrown and scattered from the lower rotating plate along the conveying surface, so that the powder is mainly attached to a side surface of the food product. However, the powder is attached to upper and lower parts in the side surface of the food product more, while to an intermediate part in the side surface less, so that uneven attachment is caused.

Further, in a region between a lower inclined surface (a side surface of an inverted truncated cone), which is located between the side surface and a bottom surface of the food product, and the conveying surface, air pocket is caused due to air flow generated by rotations of the rotating plate. It may be difficult for the powder to be attached to the lower inclined surface of the food product. When a rotational speed of the rotating plate is increased to try attaching the powder to the lower inclined surface, the air flow may become faster, so that the powder once attached to the food product may be peeled off.

In the powder attachment device described in the Patent Document 2, a height level of throwing the powder due to a centrifugal force from a tip of the rotating brush can be adjusted by moving the inclined plate to a desired inclined direction by using the moving device. Further, this powder attachment device is used when a direction of throwing the powder is arbitrarily defined, for example, when the powder is attached to a back side of a food product having a shape protruding like an umbrella, and when the powder is attached only to a portion close to a bottom surface (hem) of a tall food product. Thus, it is difficult to attach the powder to a broader area in an entire surface of the food product.

Thus, an object of the present invention is to provide a new powder attachment device and method which can attach the powder to a desired area of the surface of the food product.

### Means for Solving the Problem

To achieve the above-stated object, a powder attachment device according to the present invention includes a conveyor for conveying a food product, at least one rotating body disposed on a side of the conveyor, a powder supplying mechanism for supplying powder to the rotating body, and a control device for controlling and changing a rotational speed of the rotating body.

The control device may control and change the rotational speed of the rotating body between a lower rotational speed and a higher rotational speed alternately and repeatedly or between the lower rotational speed and the higher rotational speed continuously and repeatedly in a wave form.

Preferably, the control device periodically controls and changes the rotational speed of the rotating body.

Preferably, the at least one rotating plate attached to the rotating body is disposed lower than a placement surface of a conveying surface of the conveyor on which a food product is placed.

Preferably, the rotating shaft is disposed to be tilted outside relative to the conveyor as it goes from its bottom to its top.

Preferably, the conveyor is configured so that a portion of the conveying surface has an inverted trough shape.

Preferably, at least one rotating plate attached to the rotating body is disposed so that a portion of the rotating plate is allowed to contact and slide on the conveying surface.

In addition, to achieve the above-stated object, a powder attachment method according to the present invention for attaching powder to surfaces of a food product includes supplying powder from a powder supplying mechanism to at least one rotating body which rotates on a side of a conveyor for conveying the food product, and throwing the received powder toward the food product by rotations of the rotating plate, and rotating a rotating body to repeatedly change its rotational speed so that an area into which the powder is thrown is repeatedly varied.

Preferably, the powder is thrown obliquely and upward from the rotating body.

Preferably, the food product is conveyed by the conveyor in which a conveying surface of a belt has an inverted trough shape, and the powder is attached to a lower inclined portion of the food product.

Preferably, a portion of the rotating plate attached to the rotating body is allowed to contact and slide on the conveying surface of the conveyor so that the powder accumulated on the conveying surface is thrown toward the food product.

### Effects of the Invention

In the powder attachment device and method according to the present invention, the rotational speed of the rotating plate is controlled and changed to throw and scatter the powder to a broad range so that the powder can be attached to a broad range of the surface of the food product. Further, by conveying the food product so that the lower inclined portion and the conveying surface of the conveyer are opened, the powder can be attached to the lower inclined portion of the food product. Thus, the powder can be attached to a desired range of the surface of the food product.

### BRIEF DESCRIPTION OF THE DRAWINGS

FIG. 1 is a schematic front view of a powder attachment device according to a first embodiment of the present invention.

FIG. 2 is a schematic side view of the powder attachment device according to the first embodiment of the invention.

FIG. 3 is a schematic partially cross-sectional plan view of the powder attachment device according to the first embodiment of the present invention.

FIG. 4 is a schematic explanation view of a rotating body and a conveyor of the powder attachment device of FIG. 1.

FIG. 5 is a schematic perspective view of the powder attachment device according to the first embodiment of the present invention.

FIG. 6a is a schematic time chart for rotation control of the rotating body of the powder attachment device of FIG. 1.

FIG. 6b is a schematic time chart for rotation control of the rotating body of the powder attachment device of FIG. 1.

FIG. 7 is a schematic side view of a powder attachment device according to a second embodiment of the present invention.

FIG. 8 is a schematic perspective view of the powder attachment device according to the second embodiment of the present invention.

FIG. 9 is a schematic side view of a powder attachment device according to a third embodiment of the present invention.

FIG. 10a is a schematic explanation view of a powder attachment device according to another embodiment of the present invention.

FIG. 10b is a schematic explanation view of a powder attachment device according to another embodiment of the present invention.

FIG. 11 is a schematic explanation view of a rotating body and a conveyor of a powder attachment device according to another embodiment of the present invention.

FIG. 12 is a schematic explanation view of a rotating body and a conveyor of a powder attachment device according to another embodiment of the present invention.

### DESCRIPTION OF EMBODIMENTS

Now, referring to the drawings, a powder attachment device 1 according to a first embodiment of a device of the present invention will be explained. The powder attachment device 1 is configured to attach powder 11 to a food product 10.

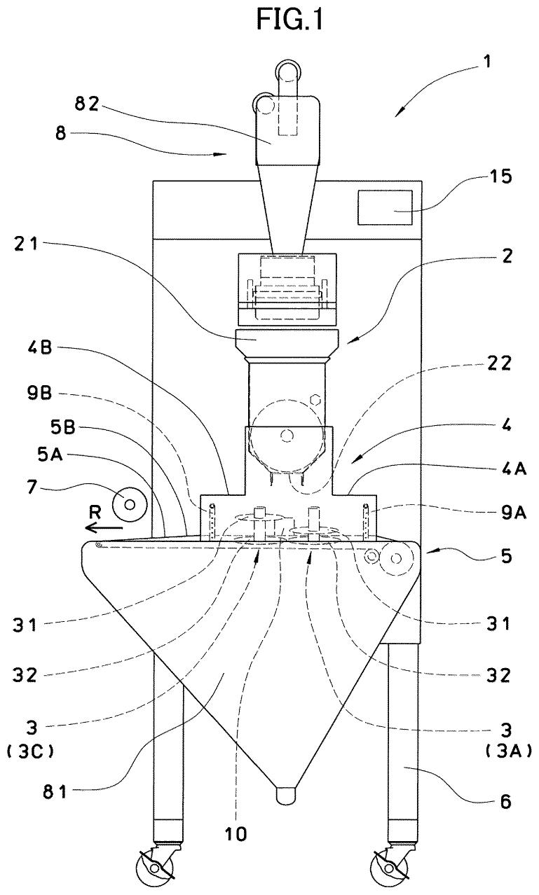

As conceptually and schematically shown in FIGS. 1 to 5, the powder attachment device 1 includes a base 6, and further includes a powder supplying mechanism 2, a rotating body 3, a box body 4, a conveyor 5, a shaping roller 7, and a powder circulating device 8, which are attached to the base 6. The powder attachment device 1 further includes a control device 15 which controls a driving operation of each part (each component).

The conveyor 5 is disposed at a lower part of the foreside (front surface) of the base 6. The conveyor 5 is configured to convey the food product 10 in a continuous or intermittent motion.

Two pairs of (four) rotating bodies 3 are disposed on each side of a conveying surface 5B of the conveyor 5 to sandwich the conveyor 5. The box body 4 is attached in foreside (front) of the base 6 to partially cover the rotating bodies 3 and the conveyor 5.

The powder supplying mechanism 2 is attached to an upper part of the box body 4, has a discharge port 22, and is configured to supply the powder 11 through the discharge port 22 to the rotating bodies 3 and the conveyor 5 disposed below the powder supplying mechanism 2. The powder supplying mechanism 2 employs a known technology, for example, described in the Patent Document 1, and its detailed explanation is omitted.

The box body 4 has an entrance 4A through which the food product 10 is conveyed in, and an exit 4B through which the food product 10 is conveyed out. The box body 4 further includes air curtains 9A, 9B disposed near the entrance 4A and the exit 4B.

The shaping roller 7 is disposed above the conveyor 5 and downstream of the exit 4B. The powder circulating device 8 includes a powder recovery slope 81 disposed below the conveyor 5 and the rotating bodies 3.

The powder circulating device 8 further includes a powder separating mechanism 82 for separating reusable powder 11 from the recovered powder 11 and is configured to supply the separated powder 11 into the powder supplying mechanism 2. The powder circulating device 8 employs a known technology, for example, described in the Patent Document 1, and its detailed explanation is omitted.

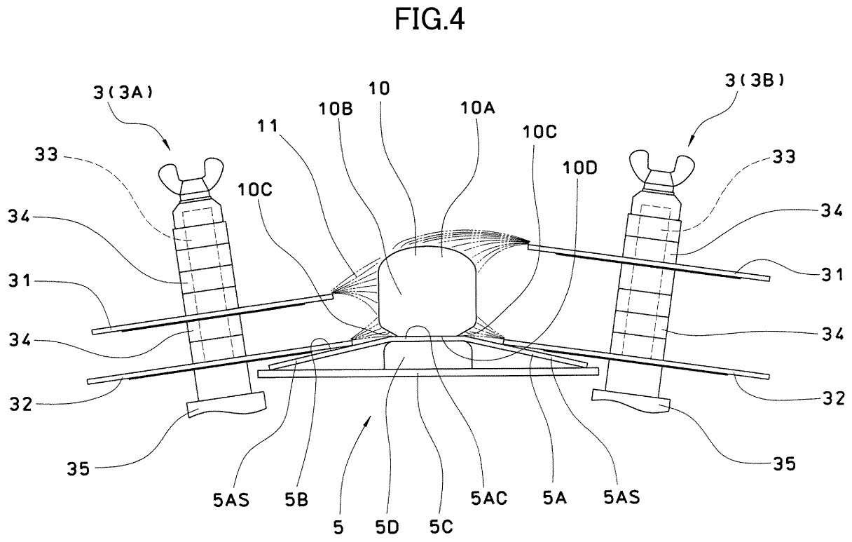

As shown in FIG. 4, in this embodiment, the conveyor 5 is a belt conveyor. The conveyor 5 has a rotating endless belt 5A. The belt 5A has a conveying surface (upper surface) 5B with an inverted trough shape, namely, a portion (a central portion in a width direction) of the conveying surface 5B protrudes upward. Specifically, the conveyor 5 includes a conveyor plate 5C and a cuboid spacer plate 5D disposed on an upper surface of the conveyor plate 5C. The belt 5A is disposed to be hung on an upper surface of the spacer plate SD, so that the conveying surface 5B includes a flat central portion 5AC centrally positioned in the width direction and an end portion SAS which is inclined downward and outside in the width direction on each side of the central portion 5AC. The central portion SAC is a flat surface on which the food product 10 is placed, and the end portion 5AS is an inclined surface. A width of the central portion SAC is preferably smaller than a width of a bottom surface 10D of the food product 10.

Each of the rotating bodies 3 is disposed on a side of the conveying surface 5B having the inverted trough shape. The rotating body 3 includes a rotating shaft 33 disposed to be tilted relative to the central portion 5AC of the conveying surface 5B (relative to a horizontal direction), and upper and lower rotating plates 31, 32 which are attached to the rotating shaft 33 and spaced from each other by a distance in a vertical direction.

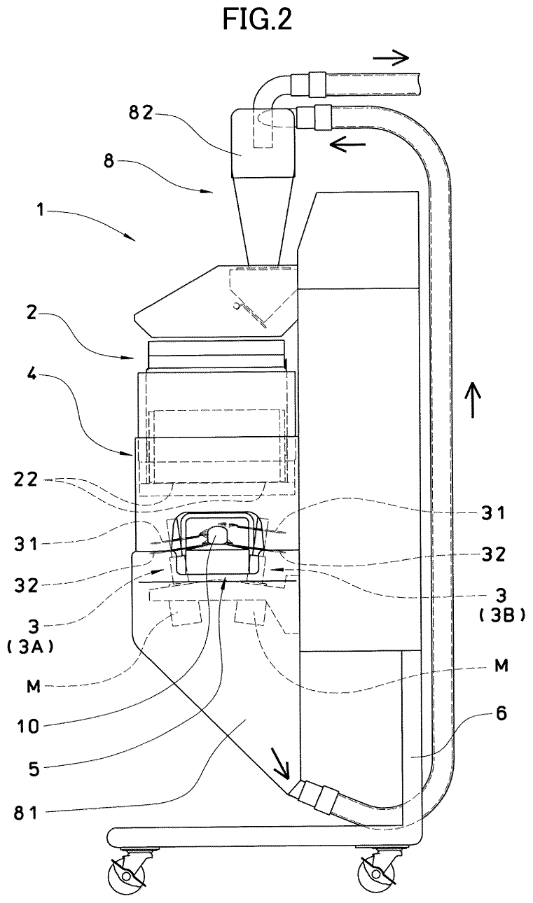

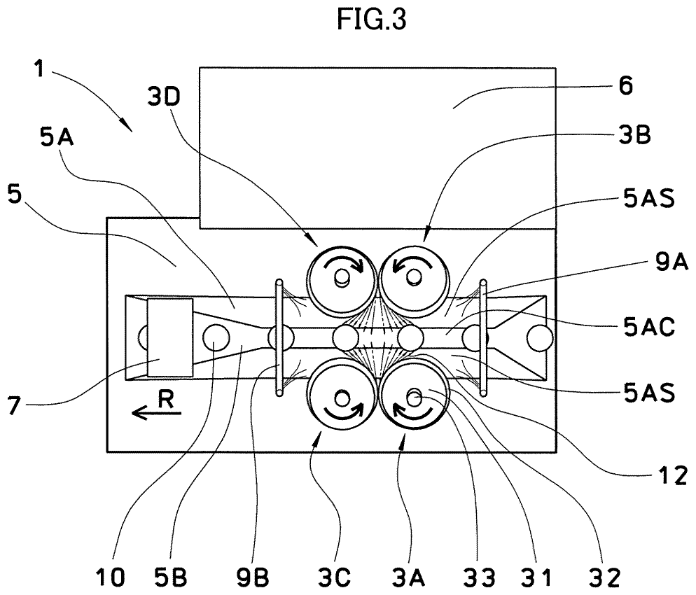

The rotating shaft 33 is tilted outside (away from the conveying surface 5B) in the width direction as it goes from its bottom to its top. As shown in FIG. 2, the rotating shaft 33 is connected to a control motor M, such as a servomotor. As shown in FIG. 3, on opposing sides of the rotating bodies 3 (on sides toward the conveyor 5), a pair of the rotating bodies 3A, 3B disposed on an upstream side in a conveying direction R of the conveyor 5 are configured to rotate in an upstream direction of the conveyor 5, while a pair of the rotating bodies 3C, 3D disposed on an downstream side in the conveying direction R are configured to rotate in a downstream direction of the conveyor 5.

Each of the upper rotating plate 31 and the lower rotating plate 32 has a thin disk shape. A diameter of the lower rotating plate 32 is larger than a diameter of the upper rotating plate 31. Each of the upper rotating plate 31 and the lower rotating plate 32 is attached to be orthogonal to the rotating shaft 33. On one side of the conveyor 5, the lower rotating plates 32 of the adjacent two rotating bodies 3 in the conveying direction R are slightly spaced so as not to interfere with each other.

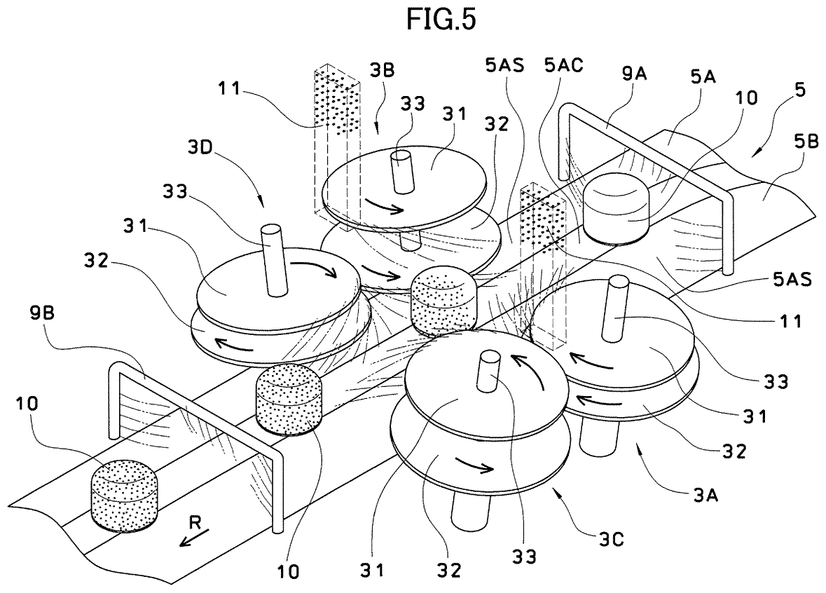

As shown in FIG. 4, the lower rotating plate 32 is disposed lower than the flat surface (the central portion 5AC of the conveying surface 5B) on which the food product 10 is placed. Further, the lower rotating plate 32 is disposed so that a portion of an outer periphery of a lower surface of the lower rotating plate 32 rotates while it contacts the end portion 5AS of the conveying surface 5B (or is allowed to contact and slide on the end portion SAS). A plurality of spacer collars 34 are sandwiched between the upper rotating plate 31 and the lower rotating plate 32, and the upper rotating plate 31 is fixed to the rotating shaft 33. A height level of the upper rotating plate 31 can be changed by changing the number of the spacer collars 34. As shown in FIG. 5, in the present embodiment, the upper rotating plates 31 of the rotating bodies 3B, 3C, which are obliquely opposed to each other to sandwich the conveyor 5 in a plan view, are disposed higher than the upper rotating plates 31 of the other rotating bodies 3A, 3D, which are obliquely opposed to each other.

The rotating body 3 is configured to rotate based on setting conditions of the control device 15. As will be explained later, by rotating the upper rotating plate 31 which is disposed to be tilted relative to the horizontal direction, the powder 11 supplied onto the upper rotating plate 31 can be thrown upward and obliquely to be scattered on a parabolic way. As such, a height to which the powder 11 is thrown can be changed according to the high and low rotational speeds of the upper rotating plate 31, so that a distance to which the powder 11 is thrown can be made farther or closer. Namely, an area into which the powder 11 is thrown can be changed.

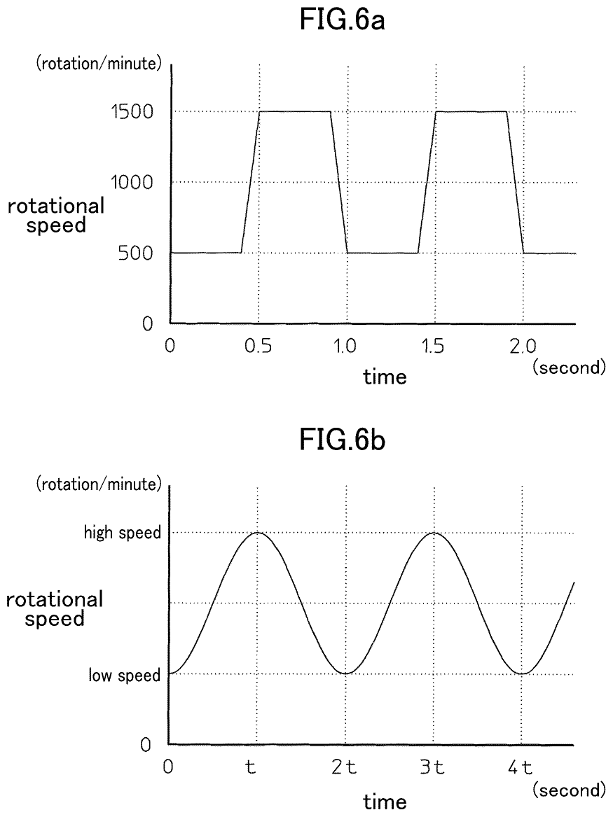

The control device 15 is configured to control a rotational speed of the rotating body 3 to be changed by controlling the rotational speed of the control motor M. Changing the rotational speed is arbitrarily, and, for example as shown in FIG. 6a, the control device 15 may control the rotational speed to be changed between a predetermined lower rotational speed and a predetermined higher rotational speed alternatively and repeatedly. For example, the lower rotational speed is 500 rotations per minute, while the higher rotational speed is 1500 rotations per minute, and the rotational speed of the rotating body 3 is controlled so that the rotational speed is changed between a lower rotational speed period at the lower rotational speed and a higher rotational speed period at the higher rotational speed (including an acceleration period of rotation and a deceleration period of rotation) periodically (every 0.5 seconds). Further, as shown in FIG. 6b, the rotational speed of the rotating body 3 may be controlled so that the rotational speed is continuously changed between a predetermined low rotational speed and a predetermined high rotational speed in a waveform (for example, a sine wave) with one cycle time of 2t seconds. The predetermined low rotational speed and/or the predetermined high rotational speed may always be the same or may change depending on time. Further, the period at the predetermined low rotational speed and the period the predetermined high rotational speed may always be the same, or may change depending on time.

Next, a method for attaching powder to a food product 10 according to the present invention by using the powder attachment device 1 according to the first embodiment of the device of the present invention will be explained. The food product 10 is, for example, a “Daifuku” rice cake, and the powder 11 is, for example, potato starch. The food product 10 has a substantially cylindrical shape, and specifically, a surface of the food product 10 includes a curved top surface 10A, a cylindrical peripheral surface 10B, a lower inclined surface (a peripheral surface of an inverted truncated cone) 10C becoming narrow as it goes downward, and a flat bottom surface 10D.

The food product (“Daifuku” rice cake) 10, which is enveloped by a known enveloping machine, is placed onto the conveyer 5. At this time, the powder 11 has already been attached to the bottom surface 10D of the food product 10. The food product 10 is conveyed into the box body 4 by rotation of the belt 5A. The powder (potato starch) 11 is supplied through the discharge port 22 of the powder supplying mechanism 2 to the upper surfaces of the upper rotating plate 31 and the lower rotating plate 32 of the rotating body 3. Due to a centrifugal force caused by rotation of the rotating body 3, the powder 11 attached to the upper surfaces of the rotating body 3 (the upper rotating plate 31 and the lower rotating plate 32) is thrown in a tangential direction 12 of the upper rotating plate 31 and the lower rotating plate 32, respectively (see FIG. 3).

At this time, by changing the rotational speed of the rotating body 3 between the high rotational speed and the low rotational speed repeatedly, the fan-shaped area into which the powder 11 is thrown repeatedly varies, or becomes wider and narrower. As shown in FIGS. 3-5, since the pair of upstream rotating bodies 3A, 3B are rotated in the upstream direction of the conveyor 5 on their opposing sides, the powder 11 thrown by the rotating bodies 3A, 3B can be mainly attached to a downstream surface (forward surface) and side surface of the food product 10 conveyed by the conveyer 5. Since the pair of the downstream rotating bodies 3C, 3D are rotated in the downstream direction of (in the same direction as) the conveyor 5 on their opposing sides, the powder 11 thrown by the rotating bodies 3C, 3D can be mainly attached to the side surface and an upstream surface (rearward surface) of the food product 10.

Further, as shown in FIGS. 4 and 5, the powder 11 is thrown upward and obliquely from the upper rotating plate 31 to be scattered on a parabolic trajectory. Further, by repeatedly changing the rotational speed of the rotating body 3, an area in the vertical direction into which the powder 11 is thrown is repeatedly moved from up to down and from down to up. In this embodiment, the powder 11 thrown from the upper rotating plates 31 of the rotating bodies 3B, 3C, which are disposed relatively high, is moved up and down mainly within an area of the top surface 10A and the peripheral surface 10B of the food product 10 to allow the powder 11 to be attached to the food product 10. Further, the powder 11 thrown from the upper rotating plates 31 of the rotating bodies 3A, 3D, which are disposed relatively low, is moved up and down mainly within a range of the peripheral surface 10B of the food product 10 to allow the powder 11 to be attached to the food product 10.

By repeatedly changing the rotational speed of the rotating body 3, a distance by which the powder 11 is thrown from the upper rotating plate 31 can be changed. By repeatedly changing the powder-thrown distance between a large one and a near one, the powder 11 can be attached to the downstream (forward) surface and the upstream (rearward) surface of the food product 10 conveyed by the conveyor 5 more than that in the conventional technology. Further, the powder 11 can be attached to the upstream (rearward) surface of the food product 10 by the pair of upstream rotating bodies 3A, 3B and to the downstream (forward) surface of the food product 10 by the pair of downstream rotating bodies 3C, 3D more than that in the prior art.

The powder 11 supplied from the powder supplying mechanism 2 onto the upper surface of the lower rotating plate 32 is thrown by allowing the lower rotating plate 32 to be disposed lower than the central portion (placement surface) 5AC of the conveying surface 5B and to be rotated and contact (to contact and slide on) the end portion (inclined surface) SAS of the conveying surface 5B (upper surface). Further, the lower rotating plates 32 of the downstream rotating bodies 3C, 3D are configured to throw the powder 11 which is deposited onto the inclined surface 5AS of the conveying surface 5B on the upstream side of the lower rotating plates 32 before the powder 11 is supplied to the upper surface of the lower rotating plates 32. The powder 11 thrown from the lower rotating plates 32 are scattered along the upper surface of the inclined surface 5AS, and is attached to a lower portion of the food product 10, especially to the lower inclined surface 10C.

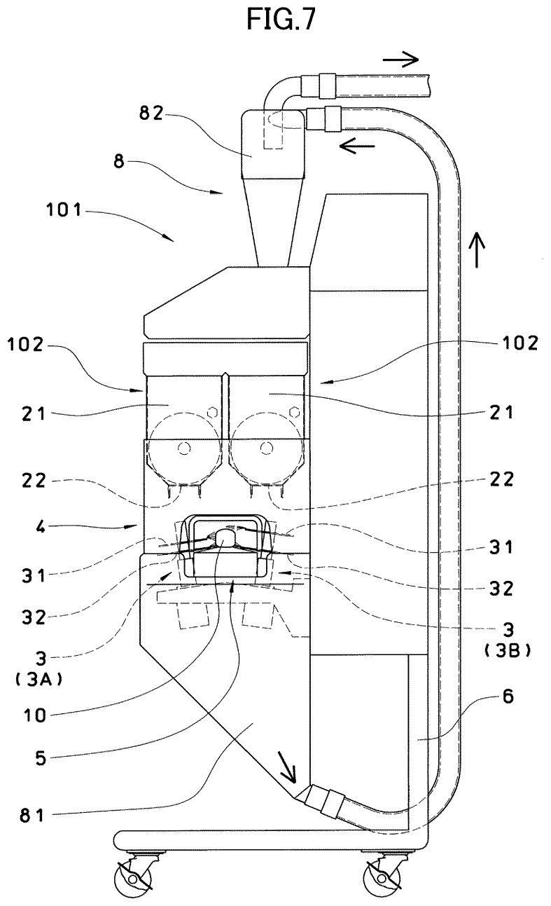

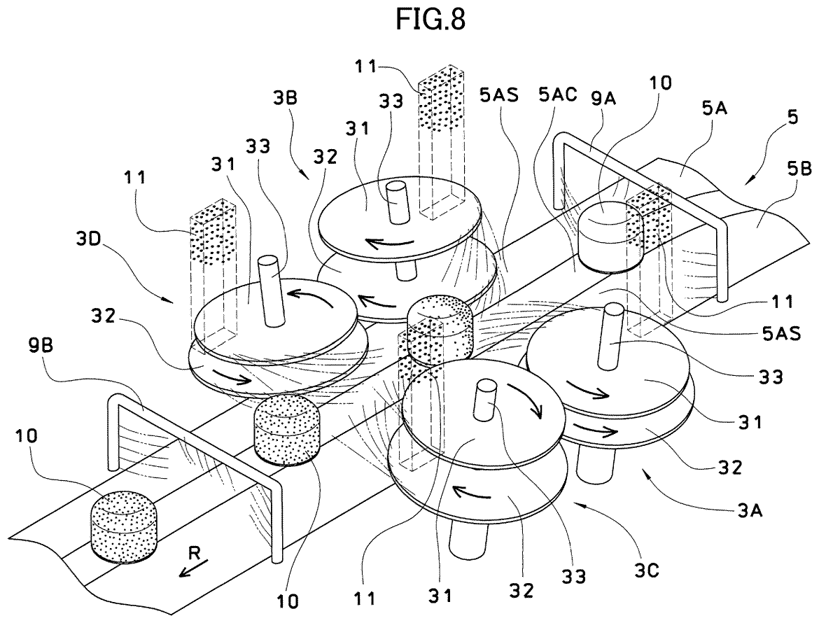

Next, referring to FIGS. 7-8, a powder attachment device 101 according to a second embodiment of the present invention will be explained. The same reference numbers as those in the powder attachment device 1 are used for components of the powder attachment device 101 which are similar to the components of the powder attachment device 1 according to the first embodiment, and detailed explanation of the components is omitted. The rotating bodies 3 of the powder attachment device 101 are configured to rotate in a different (opposite) direction from the rotating bodies 3 of the powder attachment device 1. Further, the number and arrangement of the discharge ports 22 of the powder supplying mechanism 102 of the powder attachment device 101 are different from the number and arrangement of the discharge ports 22 of the powder supplying mechanism 2 of the powder attachment device 1.

The powder attachment device 101 includes two pairs of (four) rotating bodies 3 disposed to sandwich the conveyor 5 like the powder attachment device 1. On opposing sides of the rotating bodies 3 (on sides toward the conveyor 5), a pair of upstream rotating bodies 3A, 3B are configured to rotate in the downstream direction of the conveyor 5, while a pair of downstream rotating bodies 3C, 3D are configured to rotate in the upstream direction of the conveyor 5. This allows the powder 11 thrown by the rotating bodies 3A, 3B to be mainly attached to the upstream (rearward) surface and side surface of the food product 10 conveyed by the conveyor 5, and the powder 11 thrown by the rotating bodies 3C, 3D to be mainly attached to the downstream (forward) surface and side surfaces of the food product 10. By repeatedly changing the rotational speed of the rotating body 3, the attachment effect of the powder 11 can be enhanced more than the prior art.

Further, the pair of upstream rotating bodies 3A, 3B allows the powder 11 to be attached to the downstream (forward) surface of the food product 10 more than the prior art, and the pair of downstream rotating bodies 3C, 3D allows the powder 11 to be attached to the upstream (rearward) surface of the food product 10.

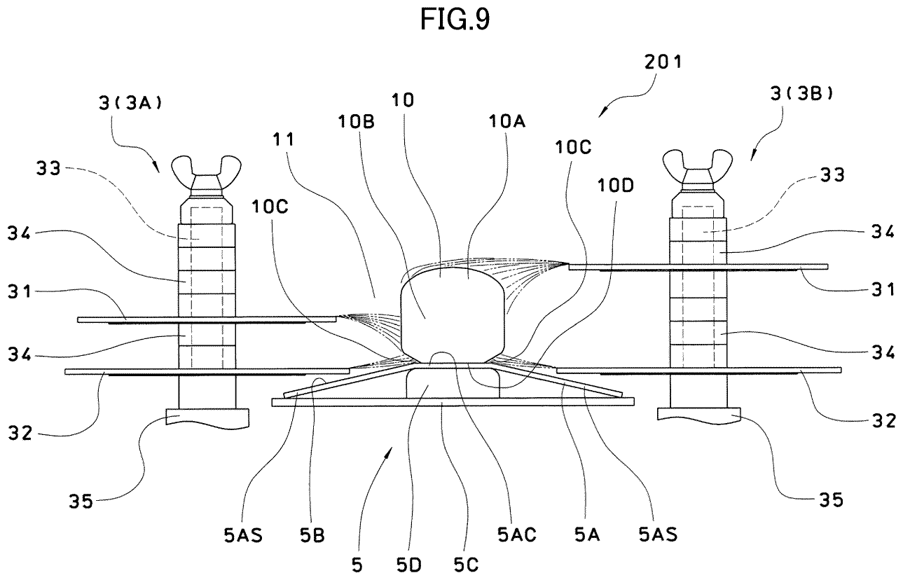

Next, referring to FIG. 9, a powder attachment device 201 according to a third embodiment of the present invention will be explained. The same reference numbers as those in the powder attachment device 1 are used for components of the powder attachment device 201 which are similar to the components of the powder attachment device I according to the first embodiment, and detailed explanation of the components is omitted. Orientation of the rotating body 3 in the powder attachment device 201 is different from orientation of the rotating body 3 in the powder attachment device 1.

The rotating shaft 33 of the rotating body 3 in the powder attachment device 201 is disposed in the vertical direction (perpendicular to the central portion 5AC of the conveying surface 5B or the horizontal direction). In the pair of upstream rotating bodies 3A, 3B in the conveying direction R, the upper rotating plate 31 of the rotating body 3B is disposed higher than the upper rotating plate 31 of the rotating body 3A. In this embodiment, the lower rotating plate 32 is disposed so that its upper surface is disposed at the same height level as or slightly lower than the central portion 5AC (placement surface) of the conveying surface SB. Further, the lower rotating plate 32 is disposed without contacting the end portion (inclined surface) 5AS of the conveying surface 5 to be slightly spaced from the belt SA. Further, the downstream rotating body 3D is configured to be similar to the rotating body 3A, while the downstream rotating body 3C is configured to be similar to the rotating body 3B.

The rotating body 3 is configured to allow its rotational speed to be changed based on setting conditions of the control device 15. The powder 11 is thrown horizontally from the upper rotating plate 31 and scattered on a parabolic trajectory. Further, by repeatedly changing the rotational speed of the rotating body 3, a vertical area into which the powder 11 is thrown is repeatedly varied.

The powder 11 thrown from the lower rotating plate 32 is scattered along the inclined surface 5AS to be attached to the lower portion, especially the lower inclined surface 10C, of the food product 10.

As described above, according to the present invention, by controlling and changing the rotational speed of the rotating body 3 so that the area into which the powder 11 is scattered is repeatedly varied, it is possible to scatter the powder 11 over a wide range and attach the powder 11 to a wide range of the surface of the food product 10. Further, by disposing the rotating plate 31, 32 to be tilted relative to the horizontal direction, the area into which the powder 11 is scattered can be further widened.

Further, since the lower inclined surface 10C of the food product 10 is opened relative to the conveying surface 5B by defining the conveying surface 5B in the inverted trough shape, an air pocket between the food product 10 and the conveying surface 5B can be prevented from being caused relative to a conventional flat conveying surface, so that the powder 11 can be stably attached to the food product 10, especially its lower inclined surface.

Although the powder attachment devices 1, 101 according to the embodiments of the present invention are generally explained above, the present invention is not limited to the embodiments, and various modifications can be made within the scope of the claims.

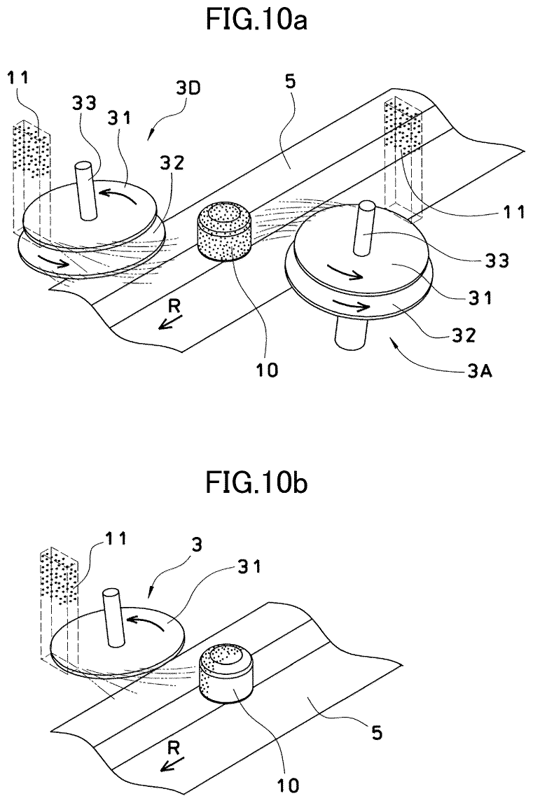

For example, as shown in FIG. 10a, the rotating body 3 may be disposed at two locations to sandwich the conveyor 5. In this case, one rotating body 3A is disposed on an upstream side of the conveyor 5, while the other rotating body 3D is disposed on a downstream side of the conveyor 5, so that the effect of attaching the powder 11 to the entire surface of the food product 10 can be obtained.

Further, although the powder attachment device 1, 101, 201 includes two pairs of (four) rotating bodies 3, the number of the rotating plate attached to the rotating body may not be more than one, namely, only the upper rotating plate 31 may be provided, as shown in FIG. 10b. Further, the rotating body 3 may be disposed only on one side of the conveyor 5, when the powder 11 is attached to a portion of the food product 10. In this way, the number and arrangement of the rotating bodies 3 and the number of the rotating plates can be appropriately selected depending on portions of the food product to which the powder is attached.

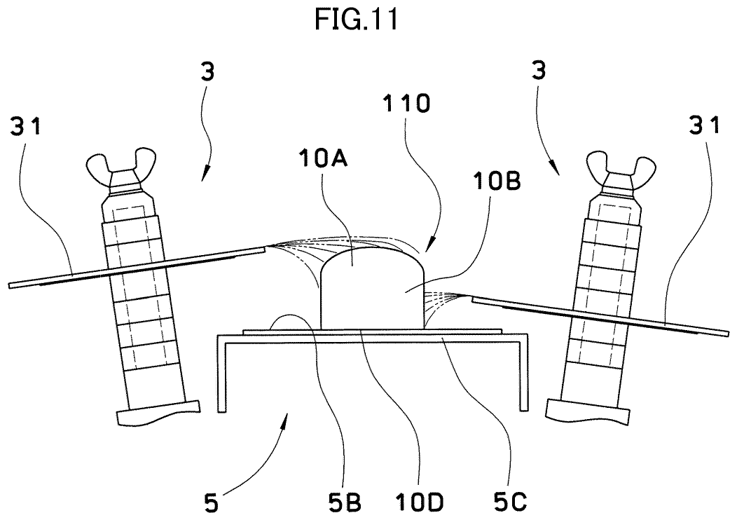

As shown in FIG. 11, when the food product 110 does not has a shape without the lower inclined surface, it is not necessary to throw the powder 11 from a location below the food product 110 to attach the powder 11 to the top surface 10A and the peripheral surface 10B of the food product 110. In this case, the conveying surface 5B of the conveyor 5 may be flat rather than has the inverted trough shape.

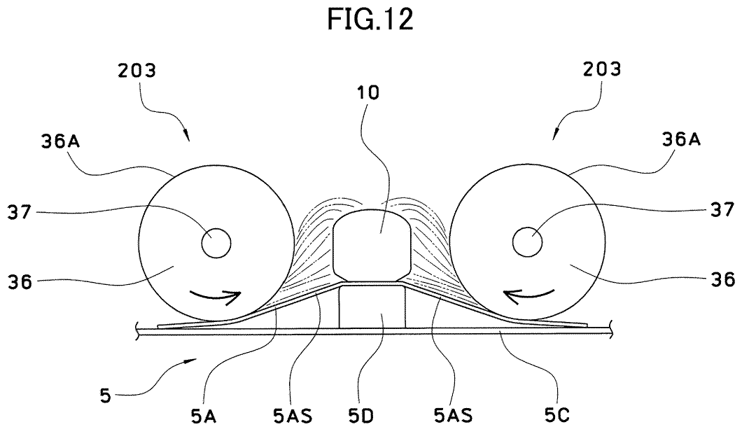

Further, to throw the powder 11, which is accumulated on the conveying surface 5B, toward the food product 10, for example, a rotating body 203 shown in FIG. 12 may be employed. The rotating body 203 includes a rotating shaft 37 disposed in a horizontal direction, and a rotating plate 36, which is attached to the rotating shaft 37 and has a required thickness, and the rotating body 203 is preferably configured to allow an outer periphery (peripheral surface 36A) of the rotating plate 36 to rotate and, at the same time, contact (to contact and slide on) the inclined surface SAS. By adding the rotating body 203 to the powder attachment device 201 or the like, more powder 11 can be scattered around the food product.

Further, although time periods for 500 rotations (at the low rotational speed) and 1500 rotations (at the high rotational speed) of the rotating body are approximately the same in FIG. 6a, a ratio of the time periods for the high rotational speed and the low rotational speed within one cycle of the speed change control may be changed depending on situations of attachment of the powder to the food product. For example, when the attachment of the powder to the upper part of the food product is more and the attachment of the powder to the lower part is less, the time period for the high rotational speed may be shortened and the time period for the low rotational speed may be lengthened, so that the powder could be attached to the food product without unevenness.

Further, in the change in the rotational speed of the rotating body shown in FIG. 6a, a time period for rotating at an intermediate rotational speed may be added between the time periods for the low rotational speed and the high rotational speed. Further, a plurality of intermediate rotational speeds may be added to change the rotational speed step-by-step.

The rotating body 3 may be a rotating brush (“hake”) described in the Patent Document 3. In this case, by employing the conveying surface of the conveying belt with the inverted trough shape, the powder can be attached to the lower inclined surface of the food product conveyed by the conveyor.

Further, by changing the rotational speed of the rotating brush (“hake”) to change a force for throwing the powder when the rotating brush contacts the pins, the area toward the powder is thrown can be repeatedly varied. Further, by tilting the rotational shaft relative to the horizontal direction, namely, toward its outside in the width direction as it goes from the bottom to the top, the powder is thrown obliquely and upward so that the powder can be scattered further.

In the above-stated embodiment, the rotating body 3, 203 may be configured to allow a position of the rotating shaft 33, 37 to be adjusted in the width direction relative to the conveying direction R. This allows a distance between the rotating body 3, 203 and the food product 10, 100 (namely, a distance between the rotating body 3, 203 and the conveying surface 5B of the conveyor 5) to be adjusted according to weight of the powder 11. By doing so, attachment of the powder 10 to the food product 10, 100 can be adjusted. For example, when the powder is relatively heavy such as starch, attachment condition tends to vary according to the change in the distance.

Other changes except for the change in the rotational speed of the rotating body 3 shown in FIGS. 6a and 6b are also allowed. For example, in the first embodiment, by shifting timings (or an order) of changing in the rotational speeds of the four rotating bodies 3A, 3B, 3C, 3D clockwise or counterclockwise in the plan view, the powder 11 is scattered in a spiral form to enhance the entire attachment of the powder 11 to the food product 10. Further, the timings of changing the rotational speeds of the four rotating bodies 3A, 3B, 3C, 3D are arbitrary, namely, they may be the same as or different from each other. Further, the predetermined low rotational speed and/or the predetermined high rotational speed of the four rotating bodies 3A, 3B, 3C, 3D may be the same as or different from each other. Further, the time periods for rotating the four rotating bodies 3A, 3B, 3C, 3D at the predetermined low rotational speed and/or the predetermined high rotational speed may be the same as or different from each other. By using a combination of these changes in the rotational speeds, the powder 11 may be scattered randomly to adjust the area into which the powder 11 is scattered, and to enhance the attachment of the powder 11 to the entire food product 10.

The embodiments and alternatives described above may be arbitrarily combined.
1, 101, 201: powder attachment device
3, 3A, 3B, 3C, 3D, 203: rotating body
31: upper rotating plate
32: lower rotating plate
33: rotating shaft
5: conveyor
5AC: central portion (placement surface)
5AS: end portion (inclined surface)
5B: conveying surface
10, 110: food product
11: powder

1. A powder attachment device for attaching powder to a surface of a food product, comprising:
a conveyor including a conveying surface for conveying the food product, and
at least one rotating body disposed on a side of the conveying surface,
wherein the rotating body is configured to throw the powder toward the food product, which is conveyed on the conveying surface, by rotation of the rotating body, and to repeatedly change a rotational speed of the rotating body while the powder is thrown.

2. The powder attachment device according to claim 1,
wherein while the rotating body throws the powder, the rotating body is configured to change its rotational speed between a predetermined low rotational speed and a predetermined high rotational speed alternately and repeatedly, or between a predetermined low rotational speed and a predetermined high rotational speed continuously and repeatedly.

3. The powder attachment device according to claim 1,
wherein the rotating body is configured to periodically change its rotational speed while the rotating body throws the powder.

4. The powder attachment device according to claim 2,
wherein the rotating body defines a plurality of the rotating bodies,
wherein the low rotational speeds and/or the high rotational speeds of the plurality of rotating bodies are the same as or different from each other, and
wherein time periods during which the plurality of rotating bodies rotates at the low rotational speeds and/or time periods during which the plurality of rotating bodies rotates at the high rotational speed are the same as or different from each other.

5. The powder attachment device according to claim 1,
wherein the rotating body defines two pairs of rotating bodies which are disposed to sandwich the conveying surface, and
wherein timings of changing the rotational speeds of the two pairs of rotating bodies are configured to shift clockwise or anti-clockwise in their plan view. cm 6. The powder attachment device according to claim 1,
wherein the rotating body defines a plurality of rotating bodies, and
wherein timings of changing the rotational speeds of the plurality of rotating bodies are the same as or different from each other.

7. The powder attachment device according to claim 1,
wherein the rotating body includes a rotating shaft disposed to be tilted relative to a horizontal direction, and a rotating plate or a rotating brush attached to the rotating shaft, and
wherein the rotating shaft is tilted away from the conveying surface as the rotating shaft goes from its bottom to its top.

8. The powder attachment device according to claim 1,
wherein the conveying surface includes a flat central portion and end portions inclined downward and outside in a width direction on both sides of the flat central portion, and
wherein the rotating body is configured to throw the powder from a height level lower than the central portion of the conveying surface.

9. The powder attachment device according to claim 8,
wherein the rotating body includes a rotating plate attached to a rotating shaft, and an outer periphery of the rotating plate is configured to rotate and, at the same time, contact the end portion of the conveying surface.

10. The powder attachment device according to claim 1,
wherein the rotating body includes a rotating shaft disposed perpendicularly to a horizontal direction or to be tilted, and a rotating plate or a rotating brush attached to the rotating shaft, and
wherein a distance between the conveying surface and the rotating shaft is adjustable.

11. (canceled)

12. (canceled)

13. (canceled)

14. (canceled)
